(19) United States
(12) Patent Application Publication
(10) Pub. No.: US 2026/0093332 A1
(43) Pub. Date: Apr. 2, 2026

(54) SYSTEMS AND METHODS FOR CALIBRATION AND OPERATION OF ACTION CONTROLS

(71) Applicant: NBCUniversal Media, LLC, New York, NY (US)

(72) Inventor: Eric Powers, Burbank, CA (US)

(21) Appl. No.: 18/904,810

(22) Filed: Oct. 2, 2024

(51) Int. Cl. G06F 3/01; G06F 3/0484

(52) U.S. Cl. CPC G06F 3/017; G06F 3/0484

(57) ABSTRACT

Systems and methods for receiving a control input, receiving one or more user actions to implement the control input, and training a model to associate the one or more user actions with the control input. The computer-implemented method also includes identifying, via the trained model, the one or more user actions, identifying, via the trained model, an associated control input, and implementing the associated control input.

### BACKGROUND

The present disclosure relates generally to improved systems and techniques for action controls. For example, the present disclosure describes a machine learning model trained to correlate one or more action controls to execute inputs, resulting in, among other things, increased control of digital user inputs.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Traditional input devices such as computer mouse(s) and stylus pen(s) provide two-dimensional input to control digital actions within operating systems and/or software programs. However, versatility and efficiency of complex inputs such as animation effects via traditional input devices are limited. Previously available motion capture devices may be used to generate complex inputs by converting user inputs into animation effects. However, use of traditional motion capture devices involves using a large amount of space, as generation and collection of user inputs are based on full-range movements of an entire human body attached to traditional motion capture devices. The large amount of space needed to use traditional motion capture devices limits applications of motion capture devices. Therefore, a need exists to develop improved techniques for versatile and efficient capture of complex inputs to devices.

### BRIEF DESCRIPTION

Certain aspects commensurate in scope with the originally claimed subject matter are summarized below. These aspects are not intended to limit the scope of the claimed subject matter, but rather these aspects are intended only to provide a brief summary of possible forms of the subject matter. Indeed, the subject matter may encompass a variety of forms that may be similar to or different from the aspects set forth below.

In one aspect a computer-implemented method includes receiving a control input, receiving one or more user actions to implement the control input, and training a model to associate the one or more user actions with the control input. The computer-implemented method also includes identifying, via the trained model, the one or more user actions, identifying, via the trained model, an associated control input, and implementing the associated control input.

In one aspect, a system may include processing circuitry and memory accessible by the processing circuitry, the memory storing instruction that, when executed by the processing circuitry, cause the processing circuitry to perform operations including identifying, via a trained model, one or more user actions, identifying, via the trained model, an associated control input, and implementing the associated control input.

In one aspect, a non-transitory computer-readable storage medium may be provided that includes processor-executable routines that, when executed by processing circuitry, cause the processing circuitry to receive a control input, identify one or more key features within a user area, wherein the key features are monitored to determine if one or more user actions are executed, and receive the one or more user actions to implement the control input. The processing circuitry also receives a control input to train training a model to associate the one or more user actions with the control input, identify, via the trained model, the one or more user actions, identify, via the trained model, an associated control input, and implement, via a user interface, the associated control input.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a diagram, illustrating a system having a cloud architecture in which aspects of the present techniques may operate including an action control system;

FIG. 2 is a flowchart, illustrating a process for calibrating and implementing an action control system based on user actions, in accordance with certain aspects of the current application;

FIG. 3 is a flowchart, illustrating a process for training a model of the action control system to execute implementation of the action control system, in accordance with certain aspects of the current application;

FIG. 4 is a flowchart, illustrating a process for implementing the trained model of FIG. 3, in accordance with certain aspects of the current application;

FIG. 5 is a schematic of a user interface of the action control system during training of a model, in accordance with certain aspects of the current application;

FIG. 6 is a schematic of the action control system implementing one or more control inputs based on user actions, in accordance with aspects of the present technique; and

FIG. 7 is a schematic of the action control system implementing a user action sequence associated with implementation of an animation sequence, in accordance with certain aspects of the current application.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As discussed above, conventional computer mouse(s) and stylus pen(s) provide inputs to a two-dimensional interface (e.g., screen) limiting dimensional control of inputs to two dimensions. In some instances, stylus pen(s) are configured to direct control of inputs in more than two dimensions, however precise control of complex actions is challenging. Motion capture device(s) have previously been used in contexts such as animation to increase dimensional control of device inputs, providing three-dimensional input to affect three-dimensional animation effects. Traditional motion capture devices directly map motions of a user to commands within an operating system and/or a software application (e.g., animation software). For example, motion capture device(s) may be used to directly map a jumping sequence executed by the user to an animated jumping sequence of an animated figure. Direct mapping of user inputs to animated figures may limit animation flexibility and efficiency. For example, direct mapping of user inputs may be limited in scenarios in which the user cannot mimic desired actions of the animated figure. Further, creation and generation of animations may include repetition of animated sequences requiring the user to repetitively provide inputs via motion capture device(s) impacting efficiency of animation. Accordingly, there is a need for implementing systems and methods to streamline repetitive animation sequences, utilize personalized inputs to control complex actions in three dimensions, and utilize user actions (e.g., expression, gestures, movements, sounds) to control computing operations.

An action control system is described herein to calibrate user (e.g., a user, a group of users, or a combination thereof) actions to direct inputs within operating systems and/or software applications to streamline and enhance efficiency of controlling complex actions within operating system and/or software applications. The action control system includes a machine learning model (MLM) that may be calibrated and/or trained to identify user expressions, gestures, movements, sounds, or a combination thereof to execute one or more inputs (e.g., digital actions). In this manner, the action control system may perform a calibration step to generatively map user actions to the one or more inputs. The action control system may calibrate the user actions (e.g., facial expressions, gestures, sounds) to be used as an animation input device. In some aspects, the action control system may enable mismatched mapping to animation inputs. For example, a thumbs up may be calibrated to control an animated figure to jump. In this manner, the action control system may directly control inputs within animation software without receiving an input of a user jumping. As such, the action control system may improve efficiency and versatility of user actions to control inputs impacting a virtual environment (e.g., animation environment). Additionally, present embodiments include a graphical user interface (GUI) designed to present calibration controls, train a machine learning model, and execute inputs based on user actions of the action control system in a concise and organized format, which enables streamlining of implementation of user inputs into existing platforms of an operating system and/or a software application.

In some aspects, the action control system may include one or more input devices to receive one or more user actions. The input devices may include cameras, displays, microphones, controllers, and one or more additional sensors. The input devices may be used to identify key features of a user or a group of users indicative of the user actions. The key features (e.g., gestures, movements, sounds) may be used to calibrate a model using machine learning. For example, a camera may be used to monitor a key feature such as a movement of a thumb and pointer finger of a user's hand. The movement of the thumb and pointer finger may be calibrated to control a zoom effect within the operating system and/or the software application. For example, movement of the thumb and pointer finger away from each other may be associated with zooming out while movement of the thumb and pointer finger towards each other may be associated with zooming in. The action control system may be implemented to improve interaction within the operating system and/or the software application through implementation of action-based user controls.

In some aspects, the action control system may be used to enable coordination between user actions and an animated sequence. The action control system may be calibrated to associate a series of animation effects to a series of user actions. The series of animation effects may include controlling motion of an animated figure. For example, actuation of an alligator mouth may include a closed position, an intermediate position, and an open position. The action control system may be calibrated to map positions of actuation of the alligator mouth with a particular user action sequence, such as a clap of hands of the user. The closed position may be executed when the user's hands are in a clasped position. The intermediate position may be executed as the user's hands are initially moved apart from one another. The open position may be executed when the user's hands are moved apart to a predetermined distance. In this manner, the user action (e.g., clap) may be used to control an extent of actuation of the alligator mouth based on calibration of the user action to the series of animation effects.

In some aspects, the action control system may be used to enable control of inputs based on a combination of user actions. User actions may include a combination of an audible command and a movement or gesture. For example, user actions may include the audible command to “jump” and a right-handed wave. The audible command to “jump” accompanied by the right-handed wave may be calibrated by the action control system to execute a right-handed jump of an animated figure. Additionally and/or alternatively, the audible command to “jump” accompanied by a left-handed wave may be calibrated by the action control system to execute a left-handed jump of the animated figure. It should be noted that audible commands may be used to control inputs such as animation independently of motion-based inputs. For example, the action control system may be used to calibrate the audible command “jump right” to direct the animated figure to execute the right-handed jump.

In some aspects, the action control system may be used to execute one or more inputs that are non-animation related controls. For example, the action control system may be used to control a position of a camera within the animation software to direct capture of frame-to-frame shooting of animation. The action control system may calibrate movement of a user hand in three dimensions to control the position of the camera within the animation software similar to movement of a camcorder. Further, in some aspects, the action control system may execute non-animation related controls such as opening a file, saving a file, deleting a portion of a file, and the like. The non-animation related controls may be calibrated to correspond to user actions such as a thumbs up, a smile, a head nod, and the like. Implementation of the action control system may provide improved versatility and granularity in control of inputs within operating system and software applications enhancing accessibility and efficiency of user-based action control in multiple dimensions.

In some aspects, the action control system may be used to enable control of a special effects system. The action control system may receive user actions to control one or more special effects (e.g., interactive storytelling, audience participation, and the like). User actions may include inputs from a group of users and may include audible commands, movements, gestures, or a combination thereof. For example, the user actions may include audience movements such as sitting and standing, raising hands, waving, leaning, ducking, mimicking interaction with objects (e.g., blaster, steering wheel, windshield washers), and the like. As such, inputs from the group of users may be used to enhance guest experiences in contexts such as a movie theatre, theme park attraction, additional themed experiences, and the like. The action control system may receive user inputs such as an audience standing from a seated position to control an animation effect generated via a projector such as motion of a character projected on a display.

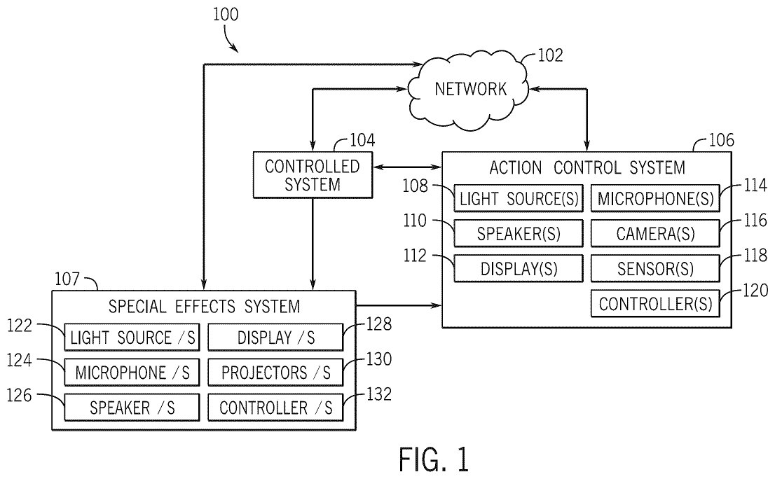

With the preceding in mind, the following figures relate to systems and processes for calibrating, training, and implementing action-based control of inputs within operating systems and applications. Turning now to FIG. 1, a diagram is shown illustrating a system 100 for directing communication via a network 102 between a controlled system 104 and an action control system 106, in accordance with certain aspects of the current application. The network 102 may include one or more computing networks, such as local private networks (LAN), wide area networks (WAN), the Internet, and/or other remote networks, to transfer data between the network and one or more additional components of the system 100. Each of the computing networks within network 102 may contain wired and/or wireless programmable devices that operate in the electrical and/or optical domain. For example, network 102 may include wireless networks, such as cellular networks (e.g., Global System for Mobile Communications (GSM) based cellular network), and/or other suitable networks. The network 102 may also employ any number of network communication protocols, such as Transmission Control Protocol (TCP) and Internet Protocol (IP). Although not explicitly shown in FIG. 1, network 102 may include a variety of network devices, such as servers, routers, network switches, and/or other network hardware devices configured to transport data over the network 102.

The system 100 may include the controlled system 104, the action control system 106, a special effects system 107, one or more additional systems, or a combination thereof. The controlled system 104,the action control system 106, and the special effects system 107 may be communicatively coupled to the network 102 and/or one or more additional suitable components. It should be noted, that in some aspects, the special effects system 107 may be omitted from the system 100. The controlled system 104 may include a communication component, a processor, a memory, a storage, input/output (I/O) ports, a display, and the like. The communication component may facilitate communication between the network 102, the controlled system 104, and the action control system 106. Additionally, the communication component may facilitate data transfer between the controlled system 104 and the action control system 106, such that the controlled system 104 may provide and/or receive data from the action control system 106. In some aspects, the controlled system 104 may be a computing system and/or an application. As used herein, the term “application” refers to one or more computing modules, programs, processes, workloads, threads and/or a set of computing instructions executed by a computing system. For example, the controlled system 104 may be an animation software that may be controlled by the action control system 106 to execute inputs based on user actions.

For example, the controlled system 104 may receive data such as user action data to control inputs within the controlled system 104. The processor may be any type of computer processor or microprocessor capable of executing computer-executable code. The processor may also include multiple processors that may perform the operations described herein (e.g., the operations may be distributed between the multiple processors that together form processing circuitry, such that one processor performs one operation, another processor performs another operation, and so on). Indeed, the operations may be distributed between the processor and/or any other processor of the system 100 in any suitable manner.

The memory and the storage may be any suitable articles of manufacture that can serve as media to store processor-executable code, data, or the like. These articles of manufacture may represent computer-readable media (e.g., any suitable form of memory or storage) that may store the processor-executable code used by the processor to perform the presently disclosed techniques. The memory and the storage may also be used to store data (e.g., user actions, audio inputs), various other software applications for analyzing the data, and the like. The memory and the storage may represent non-transitory computer-readable media (e.g., any suitable form of memory or storage) that may store the processor-executable code used by the processor to perform various techniques described herein. It should be noted that non-transitory merely indicates that the media is tangible and not a signal.

The display may operate to depict visualizations associated with software or executable code being processed by the processor. In certain aspects, the display may be a touch display capable of receiving inputs from a user of the system 100. The display may be any suitable type of display, such as a liquid crystal display (LCD), plasma display, or an organic light emitting diode (OLED) display, for example. Additionally, in certain aspects, the display may be provided in conjunction with a touch-sensitive mechanism (e.g., a touch screen) that may function as part of a control interface for the action control system 106. In some instances, a user interface of the controlled system 104 and/or the action control system 106 may be presented on the display. It should be noted, the action control system 106 may include communication components, processors, memory, storage, input/output (I/O) ports, displays, and the like as discussed above in reference to the controlled system 104.

The action control system 106 may include various devices to facilitate collection of user actions. The devices may include one or more light source(s) 108 (e.g., LEDs), one or more speaker(s) 110, one or more display(s) 112, one or more microphone(s) 114, one or more camera(s) 116, one or more sensor(s) 118, one or more controller(s) 120, or a combination thereof. The display(s) 112 may be any suitable type of display, such as a liquid crystal display (LCD), plasma display, or an organic light emitting diode (OLED) display, for example. Additionally, in one aspect, the display(s) 112 may be provided in conjunction with a touch-sensitive mechanism (e.g., a touch screen) that may function as part of a control interface for the action control system 106. Further, in some aspects, the action control system 106 may include an application program interface (API) designed to provide, display, and/or receive inputs related to user actions. For example, in some aspects, the API may provide notification of user actions received by the action control system 106, confirmation requests, and the like. As used herein, the term API may be defined as a communication protocol between the action control system 106 and a server, or in other words an interface implemented by an application, which allows other applications to communicate with it. An API may include a set of functions, methods, classes, or protocols that an operating system, library, or service provides to support requests made by computer programs. For example, the API may be used to interface with the controlled system 104. As such, the API may include a graphical user interface (GUI). The GUI may be used to receive queries associated with the user actions and/or feedback data provided by one or more components of the action control system 106.

The controller(s) 120 of the action control system 106 may control activation of audio recordings, and/or visual recordings corresponding to user actions of the action control system 106. As such, the user actions that may include audio inputs, visual inputs, and the like may be captured by the microphone(s) 114 and the camera(s) 116, respectively to direct inputs used in the controlled system 104.

In some aspects, the one or more sensor(s) 118 of the action control system 106 are used to monitor a user area and detect a presence of a user or a group of users within the user area. As such, the sensor(s) 118 may sense the presence and/or the position of the user and generate sensor data (e.g., user action data) and/or activate the action control system 106 to be in an active state. The sensor(s) 118 may include photodiodes, photodetectors and/or other suitable detectors used to collect sensor data. In some aspects, the one or more camera(s) 116 may include various cameras (e.g., thermal imager, complementary metal-oxide-semiconductor (CMOS) camera, charge-coupled device (CCD)), and may be positioned on or within a portion of the controlled system 104 and/or the action control system 106. The camera(s) 116 may be used to collect user actions to control inputs within the operating system and/or the software applications of the controlled system 104 and/or the action control system 106.

The processor of the action control system 106 may transmit signals to the controlled system 104 to activate one or more inputs (e.g., digital inputs) based on data collected by the microphone(s) 114, the camera(s) 116, the sensor(s) 118, and/or the controller(s) 120 of the action control system 106. For example, the data (e.g., user detection data, tracking data, identification data, audio data) may provide information about user actions within the user area. In some cases, a user may perform a user action within the user area that may be used to control input of one or more actions of the controlled system 104. In this manner, the user may be positioned in the user area and move in a way to trigger control of an associated input of the action control system 106. In other cases, the user may be absent prompting the action control system 106 to remain inactive. In some aspects, a group of users may perform user actions within the user area that may be used to control input of one or more actions of the controlled system 104. In another aspect, a group of users may perform user actions across different user areas, each user area with its respective action control system transmitting signals to a common controlled system, where the common controlled system performs one or more actions based on the combined inputs of multiple users.

In some aspects, the action control system 106 may include machine learning circuitry to provide operating functions of machine learning, including building, training, operating and/or generating predictions using a model. The machine learning circuitry may use visual machine learning and/or artificial intelligence to accurately and dynamically correlate user actions to generatively map to animation effects, control inputs, and the like. For instance, the action control system 106 may use machine learning to train itself using user actions provided from the microphone(s) 114, the camera(s) 116, the sensor(s) 118, and/or the controller(s) 120. The model may be generated using neural networks, decision trees, regression trees, natural language processing, random forest, joint distributions, conditional distributions, or the like. The model may be trained to generate a global model that may be further trained and/or calibrated by a specific user of the global model. In this manner, the global model may serve as a basis point for analyzing user actions that may be tailored based on the specific user. The model may have an encoder and a decoder trained separately or simultaneously. The encoder may compress input data such as specific user actions into a latent space. The decoder may be pre-trained to reconstruct (e.g., decode) the input data from the latent space and reconstruct the input data to perform respective animations effects, control inputs, and the like. The model may generate and save codebooks or embedded representations of encoding and decoding. The model may be trained to select among many expert models for capture, encoding, decoding, calibration, mapping, rendering, and actuation.

In some aspects, the special effects system 107 may include one or more light sources 122 (e.g., LEDs, structured lighting, laser(s), etc.), one or more microphones 114, one or more speakers 126, one or more displays 128, one or more projectors 130, one or more controllers 132, or a combination thereof. The special effects system 107 may be used to generate special effects such as show projections, lighting effects, and the like. In certain aspects, one of the controllers 82 of the special effects system 54 may include an audio and visual (A/V) controller. For example, the special effects system 107 may generate A/V effects under control of the controller 132 to provide themed projection or themed sounds to enhance a user or a group of user experience with the action control system 106. The controller 132 may control the light source 122, the microphones 114, the speakers 124, and/or one or more visual output devices (e.g., displays 128, projectors 130, etc.). For example, the controller 132 may control activation of audio recordings, and/or visual displays in response to user actions received by the action control system 106. As such, the special effects system 107 may be used to generate guest experiences in contexts such as a movie theatre, theme park attraction, themed experience, and the like.

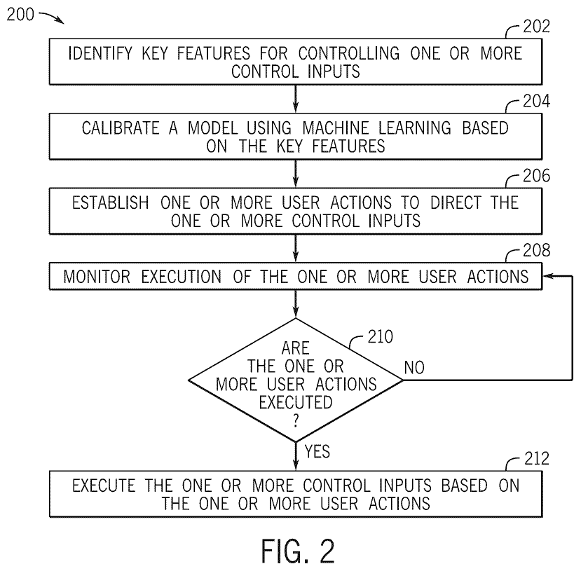

FIG. 2 is a flowchart illustrating a process 200 illustrating a process for calibrating and implementing the action control system 106 based on user actions, in accordance with certain aspects of the current application. The process 200 may be performed a computing device, a controller, or any other suitable computing device(s) or controller(s). Furthermore, the blocks of the process 200 may be performed in the order disclosed herein or in any suitable order. For example, certain blocks of the process 200 may be performed concurrently. In addition, in certain aspects, at least one of the blocks of the process 200 may be omitted. Further, it should be noted, that the controlled system 104 and/or the action control system 106 may iteratively perform the blocks outlined in process 200.

At block 202 of the process 200, the action control system 106 may identify key features for controlling one or more control inputs. The key features may include gestures, expressions, movements, sounds, and the like corresponding to anticipated user actions. In some aspects, the action control system 106 may be coupled to receive data from the microphone(s) 114 and the camera(s) 116. As such, the key features may include voice commands, facial expressions, hand gestures, movements of one or more portions of the user body, and the like. In one non-limiting example, the action control system 106 may identify key features based on a position of the camera 116. The camera 116 may be focused on a face of the user. As such, the action control system 106 may identify the key features as facial expressions of the eyes and mouth of the user. Identification of the key features may enable use of the action control system 106 in environments in which additional gestures, expressions, movements, and sounds may occur.

The one or more control inputs may be used to execute changes to the controlled system 104. For example, the one or more control inputs may direct animation of an animated figure. The one or more control inputs may be used to perform a task on the controlled system 104 such as moving an element, zooming in and/or out, saving a file, opening a file, and the like. The one or more control inputs may be used as action-based inputs of hotkeys, accelerator keys, keyboard shortcuts, and the like. In this manner, the identified key features may be assessed to identify user actions that may execute the one or more control inputs within the controlled system 104. In some aspects, the action control system 106 may provide increased accessibility to utilization of the controlled system 104. For example, users not able to input traditional keyboard shortcuts may use the action control system 106 to identify key features to execute one or more control inputs such as movement of an arm or hand, vocal commands, and the like.

At block 204 of the process 200, the action control system 106 may calibrate a model using machine learning based on the key features. The model may be trained using artificial intelligence (AI) techniques such as machine learning, neural networks, deep learning, generative AI, or a combination thereof. The model may be calibrated to a particular user. For example, the action control system 106 may identify a particular voice corresponding to the user as the key feature. In this way, additional sounds and noises may not be identified by the action control system 106 decreasing false activation of the action control system 106 as a result of environmental factors. In some instances, the model may be calibrated to associate one or more control inputs to user actions based on the identified key features.

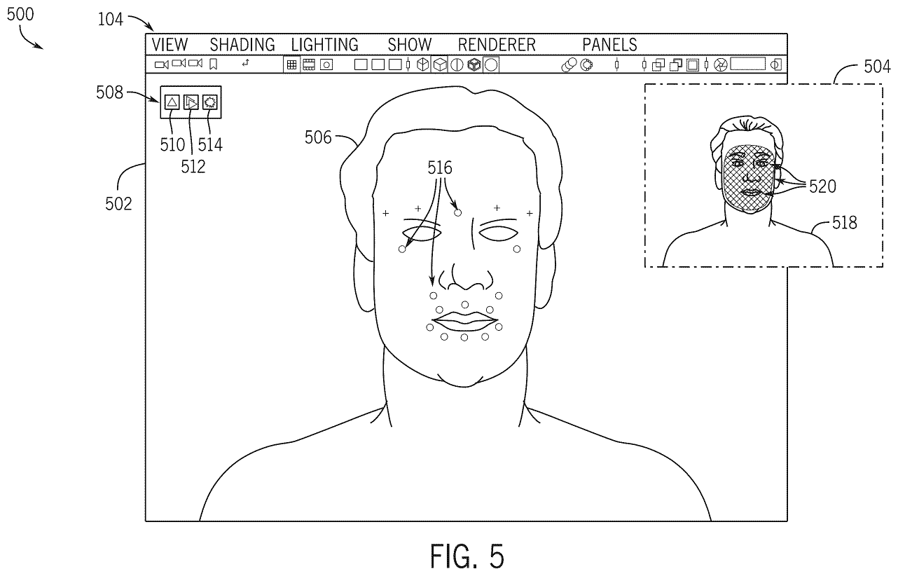

At block 206 of the process 200, the action control system 106 may establish one or more control inputs corresponding to one or more user actions. In some aspects, the user actions may be used to mimic one or more control inputs. For example, the identified key features may be facial expressions of the eyes and mouth. As such, the model may be calibrated to associate animation of mouth within an application to movement of the mouth of the user. As exampled in more detail below with regards to FIG. 5, the model may emulate an animated smile and the user may be prompted to establish a user action for association with the animated smile, such as movement of the mouth to a smile. The model may further emulate an animated frown and the user may be prompted to establish an additional user action for associated with the animated frown, such as movement of the mouth to a frown. The model may further emulate additional expressions and/or motions and direct the user to establish user actions for association with the additional expressions. It should be noted that the user actions may not mimic the control inputs.

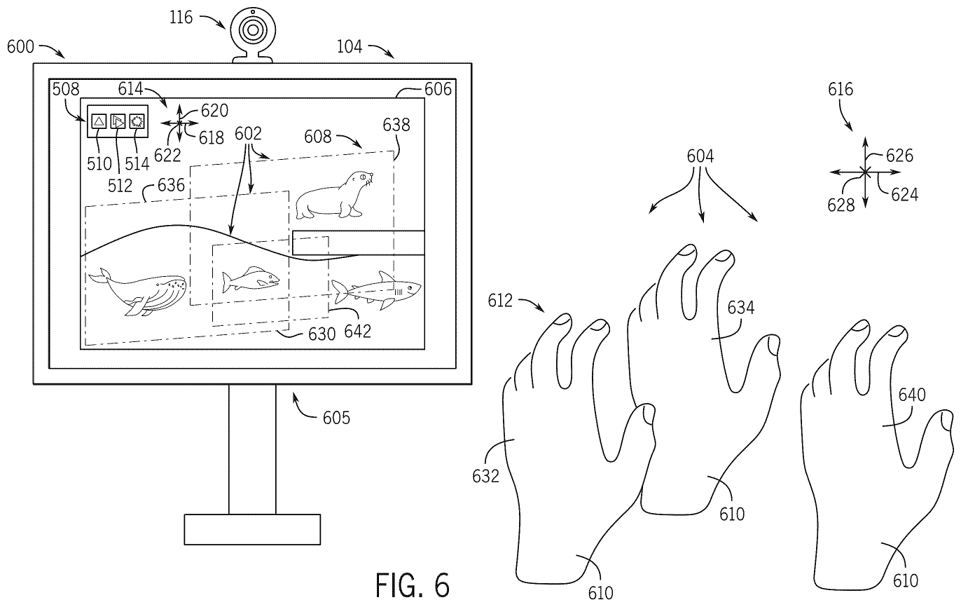

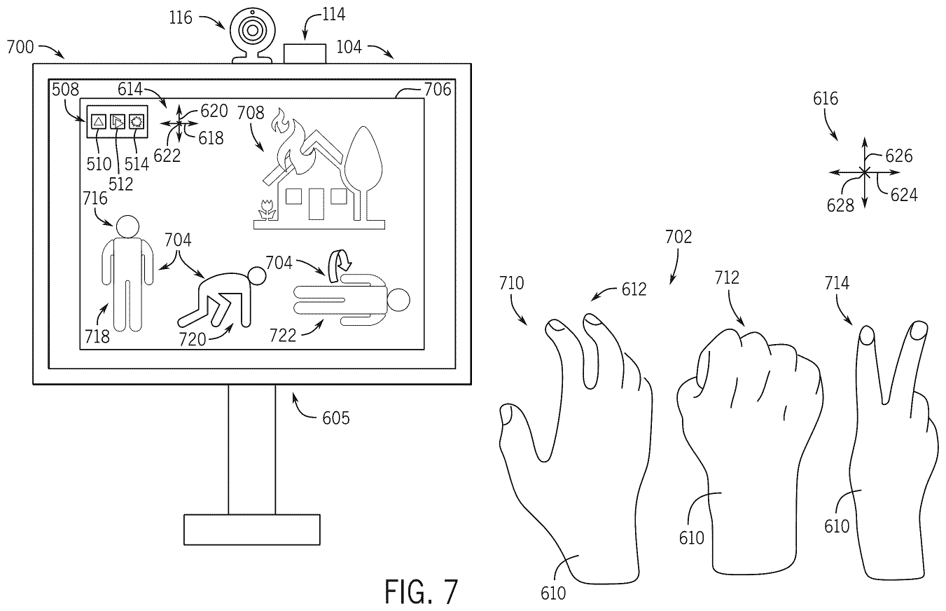

In some aspects, as described in more detail in regard to FIG. 6 and FIG. 7 the user actions may direct the one or more control inputs to execute a task that is unmatched or dissimilar to the user actions (e.g., the task or the control input does not directly mimic the user actions). For example, the model may associate the animated smile with a particular user action, such as a thumbs up. Stated differently, the model may associate a thumbs up of the user to cause the animated smile to be executed within an application of the controlled system 104. By establishing which user actions direct which control inputs, the model of the action control system 106 may provide versatility and customization to streamline workflows.

At block 208 of the process 200, the action control system 106 may monitor execution of the one or more user actions. Implementation of the action control system 106 may include monitoring inputs of components of the action control system 106 such as the microphone(s) 114, the camera(s) 116, the sensor(s) 118, and the controller(s) 120. In some aspects, the components of the action control system 106 may monitor for a presence of the user in a user area. The user area may be an area corresponding to a frame of the camera 116, a sensing area of the sensor 118, a pick-up area of the microphone 114, and the like. At block 210 of the process 200, the action control system 106 may determine if the one or more user actions are executed. In some aspects, the user actions are not executed and the process 200 may return to block 208 and continue to monitor for execution of the user actions.

In some aspects, the action control system 106 may determine that the one or more user actions are executed and proceed to block 212. At block 212 of the process 200, the action control system 106 may execute the one or more control inputs based on the one or more user actions. In some aspects, the one or more control inputs may execute a task within the controlled system 104. The task may include performing an animation effect, moving a position of an animation camera, opening a file, performing an animation sequence, activating speech, and the like.

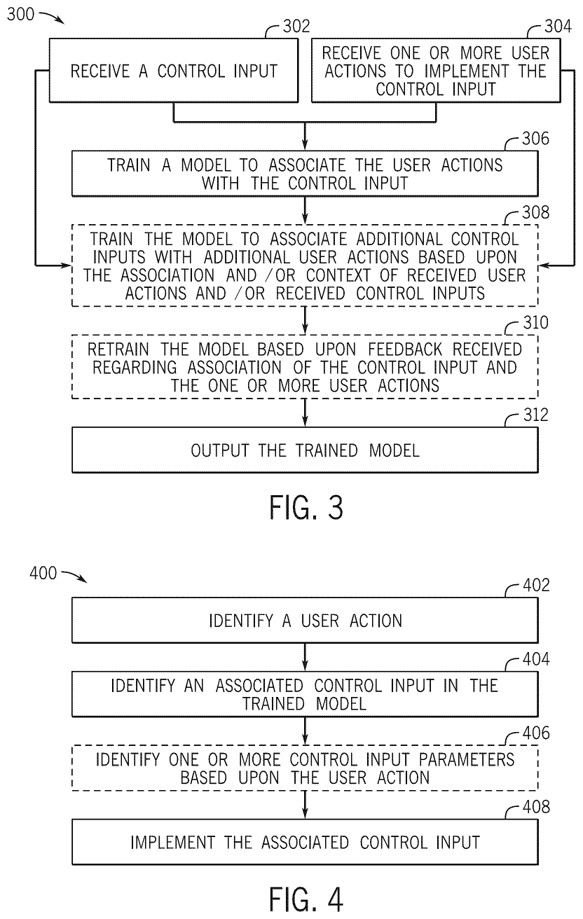

FIG. 3 is a flowchart, illustrating a process 300 for training a model of the action control system 106, in accordance with certain aspects of the current application. The process 300 may be performed a computing device, a controller, or any other suitable computing device(s) or controller(s). Furthermore, the blocks of the process 300 may be performed in the order disclosed herein or in any suitable order. For example, certain blocks of the process 300 may be performed concurrently. In addition, in certain aspects, at least one of the blocks of the process 300 may be omitted. Further, it should be noted, that the controlled system 104 and/or the action control system 106 may iteratively perform the blocks outlined in process 300.

At block 302 of the process 300, the action control system 106 may receive a control input. The control input may be provided by the controlled system 104. The control input may include a task to be implemented in an application of the controlled system 104. For example, the control input may include an animation effect, an animation sequence, a command (e.g., zoom, pan, save, open, print, copy, paste), and the like. The control input may be selected by the user to be sent to the action control system 106. For example, the action control system 106 may receive a frequently used animation sequence as the control input. The user may select the frequently used animation sequence to be controlled by the action control system 106 to increase an efficiency of animating a series of actions. The animation sequence received as the control input may include one or more key frames (e.g., start points, end points), one or more points in a motion path (e.g., position sequences of animations), and the like. For example, an animation sequence of flapping of a dragon's wings may be received by the action control system 106 as the control input. The animated sequence may include a first key frame corresponding to a wing in a rest position, a second key frame corresponding to an outstretched wing, a third key frame corresponding to a raised wing position, and a fourth key frame corresponding to a lowered wing position.

At block 304 of the process 300, the action control system 106 may receive one or more user actions to implement the control input. Continuing the example of the animated sequence, the action control system 106 may receive user actions corresponding to each key frame of the control input. The user actions may include American Sign Language numbers. For example, a first user action corresponding to the first key frame of the wing in the rest position, may include a palm facing inward with an index finger extended. The second user action, corresponding to the second key frame of the wing in the outstretched wing, may include the palm facing inward with the index finger and a middle finger extended. The third user action, corresponding to the third key frame of the wing in the raised wing position, may include the palm facing inward with the index finger the middle finger extended, and a thumb extended. The fourth user action, corresponding to the fourth key frame of the wing in the lowered wing position, may include the palm facing inward with the index finger, the middle finger, a ring finger, and a pinky finger extended.

At block 306 of the process 300, the action control system 106 may train a model to associate the user actions with the control input. The model may be trained using AI techniques. The model may be trained continuously during execution of the model within the action control system 106. In some aspects, the model may be trained using various iterations of the user actions. The model may be trained to identify the user actions based on a library of input data. The library may include data related to user actions desired to execute the control input. For example, the library of input data may include videos of users executing a particular user action such as the animated sequence. Differences in user actions due to differences in data collection may be used to train the model to improve a predictive nature of the model. Users may have different sized hands and/or fingers that may impact detection of the user actions by the action control system 106. As such, data sets may be used to train the model to account for differences between user inputs. Users may also set a tolerance level for one or more user inputs/actions that provide for a wider margin of error when performing a particular user action and/or to enable a model trained for one user to be adaptable to different users. Further, the model may be trained to reduce impacts of environmental differences during collection of the user actions. For example, background environments during data collection of the user actions may impact detection of the user actions by the action control system 106. By training the model on various data sets with different background environments, the action control system 106 may increase an ability to detect user actions and associate user actions with the control input. It should be noted that the disclosed examples are illustrative and non-limiting. For example, the model may be trained using a voice library of input data corresponding to a plurality of inputs of the voice command. In some instances, the voice library may include real-world data, simulated data, or a combination thereof. Further, the user action may be an expression or gesture captured by the cameras 116. As such, the model may be trained on a series of data of various users executing the user actions. In this manner, the model may be trained to generate a global model that may be used to identify user actions of various users.

Additionally and/or alternatively, the model may be trained using data collected from an audience. For example, each member of the audience may be directed to wave a right hand. The model may receive the user actions and train the model to associate the user actions with the control input based on the wave of the right hand of each member of the audience. The model may ignore outliers, such as members of the audience not participating (e.g., not waving the right hand). The trained model may be used to control the action control model and direct control inputs to execute tasks within the controlled system 104.

At block 308 of the process 300, the action control system 106 may train the model to associate additional control inputs with additional user actions based upon the association and/or context of received user actions and/or executed control inputs. It should be noted that block 308 is an optional block of the process 300. The additional control inputs may be received from block 302 of the process 300 and the one or more additional user actions to implement the additional control inputs may be received from block 304 of the process 300.

In some aspects, the action control system 106 may be configured to save and store various sets of user actions to execute various sets of control inputs. For example, a user of the action control system 106 may establish a first set of user actions corresponding to a first application of the controlled system 104 and a second set of user actions corresponding to a second application of the controlled system 104. The first set of user actions may include the animated sequence of flapping of the dragon's wings. The second set of user actions may include new user actions that may be selected via a GUI by the user to perform alternative and/or additional control inputs. That is, the model may be trained to associate the second set of user actions in addition to the first set of user actions or instead of the first set of user actions. For example, the second set of user actions may include a user action correlating a first control input of opening a file to a palm facing inward with the index finger extended and a second control input closing a file to a palm facing inward with no extending fingers. In this manner, the second set of user actions may replace the first set of user actions. It may be advantageous to generate multiple sets of user actions to execute various sets of control inputs to improve adaptability of the action control system 106. For example, a user (e.g., animator, artist) may be working on various projects simultaneously. As such, customization of the user actions to correspond to different control inputs may improve efficiency when moving from one project to another. In this way, the user may be able to select a particular set of user actions corresponding to a particular project.

In some aspects, various sets of user actions may be used concurrently to direct the additional control inputs. As such, the model may be trained to differentiate the various sets of user actions. For example, the first user set may be based on gestures of the users, such as the first set of user actions corresponding to the animation sequence of the flapping of dragon's wings while an audible set of user actions may correspond to control inputs controlled based on voice commands of the user. It should be noted, that in some aspects, the first set of user actions and the audible set of user actions may be implemented simultaneously. For example, user actions including the third user action, corresponding to the wing in the raised wing position and the fourth user action, corresponding to the wing in the lowered wing position may be provided to the action control system 106 in addition to a voice command corresponding to a control input to cause the dragon to breath fire.

At block 310 of the process 300, the action control system 106 may retrain the model based upon feedback received regarding association of the control input and the one or more user actions. It should be noted that block 310 is an optional block of the process 300. Feedback regarding association of the control input and the user actions may include accuracy of the model in determining and executing control inputs based on user actions of a particular user. In this manner, the model may be retrained based on differences between the particular user and the model (e.g., global model). For example, the model may be trained on a wide set of training data and then provided to the particular user. The particular user may provide feedback to the model to retrain the model based on user actions of the particular user. In this way, the model may be retrained and/or continuously trained to provide improved control inputs based on the user actions of the particular user.

At block 312 of the process 300, the action control system 106 may output the trained model. The trained model may be used to implement the action control system 106 to facilitate directing control inputs to execute user actions. It should be noted that the trained model of the action control system 106 may be continuously updated to perform additional control inputs based on additional user inputs. Additionally and/or alternatively, the trained model may undergo continuous training to increase an efficiency of association between the user actions and the control input. Further, in some aspects, the trained model of the action control system 106 may be updated using generative AI processes that may anticipate association of user actions with control inputs. In this manner, the model of the action control system 106 may be trained to suggest additional user actions and/or control inputs frequently used by the user to direct the controlled system 104.

FIG. 4 is a flowchart, illustrating a process 400 for implementing the trained model of FIG. 3 to execute implementation of the action control system 106, in accordance with certain aspects of the current application. The process 400 may be performed a computing device, a controller, or any other suitable computing device(s) or controller(s). Furthermore, the blocks of the process 400 may be performed in the order disclosed herein or in any suitable order. For example, certain blocks of the process 400 may be performed concurrently. In addition, in certain aspects, at least one of the blocks of the process 400 may be omitted. Further, it should be noted, that the controlled system 104 and/or the action control system 106 may iteratively perform the blocks outlined in process 400.

At block 402 of the process 400, the action control system 106 may identify a user action. The user action may include a gesture, movement, expression, sounds, or a combination thereof. The user action may be identified via the components of the action control system 106 (e.g., microphone(s) 114, camera(s) 116, sensor(s) 118, controller(s) 120). At block 404 of the process 400, the action control system 106 may identify an associated control input in the trained model. The associated control input may be based on the trained model of the action control system 106 as described above in reference to FIG. 3.

At block 406 of the process 400, the action control system 106 may identify one or more control input parameters based upon the user action. The control input parameters may include additional inputs associated with the user action. For example, the control input parameters may be input by a user via a GUI of the action control system 106. The control input parameters may include indication of capture of the user input, additional training of the model, selection of one or more sets of user actions, addition of one or more associated control input and user action, and the like. It should be noted, that block 406 of the process 400 is optional. In an aspect, the action control system 106 may determine (either via the trained model or via user prompting) that there is no associate control input for the user action, the action control system 106 may prompt the user for the option to associate or train the model to associate the user action with an existing or new control input.

At block 408 of the process 400, the action control system 106 may implement the associated control input. The associated control input may be executed by directing the controlled system 104 to execute a task. As such, applications of the controlled system 104 may be controlled to generate an animation effect, an animation sequence, a command (e.g., zoom, pan, save, open, print, copy, paste), or a combination thereof. In another aspect, applications of the controlled system 104 may be configured to operate a device (e.g., a robot, an animated figure, a vehicle, aerial device). Implementation of the action control system 106 may streamline repetitive animation sequences, utilize personalized inputs to control complex actions using the trained model, and utilize user actions (e.g., expression, gestures, movements, sounds) to direct control inputs to execute actions in three dimensions.

FIG. 5 is a schematic of a user interface 500 of the action control system 106 during training of a model, in accordance with certain aspects of the current application. As shown, the user interface 500 may include an API interface 502, an input device interface 504, or a combination thereof. The API interface 502 may represent an interface of an animation application of the controlled system 104. The animation application may include an animated FIG. 506. The animation application may be controlled by the action control system 106. The action control system 106 may run in a background of the animated software and/or as a plug-in of the animated software. The action control system 106 may include a parameters toolbar 508. The parameters toolbar 508 may include a user control indication button 510, a model training button 512, a user action set selection button 514, and one or more additional buttons. The parameters toolbar 508 may be used during training of the model of the action control system 106. For example, the model training button 512 may be selected within the parameters toolbar 508 to initiate training of the model of the action control system 106.

In some aspects, training of the model of the action control system 106 may be based on a user mimicking animation of the animated FIG. 506. As such, the action control system 106 may receive a first control input of the animated FIG. 506. In the illustrated example, the first control input of the animated FIG. 506 includes an animated smile and animated open eyes. The first control input of the animated FIG. 506 may be based on a position of one or more animated markers 516 of the animated FIG. 506. As shown, the animated FIG. 506 represents an animated human and the animated markers 516 are positioned to capture facial expressions of the animated FIG. 506. During training the animated FIG. 506 positioned the animated markers 516 to the position corresponding to the first control input. The input device interface 504 may display a video of a user 518 with one or more mapped markers 520. The user 518 may mimic the first control input of the animated figure. As shown, the user 518 mimics the first control input establishing a first user action by smiling with open eyes. The action control system 106 may associate the one or more mapped markers 520 of the input device interface 504 with the first control input of the animated FIG. 506 as established by the position of the animated markers 516. The model of the action control system 106 may store the association between the first control input and the first user action. The animated FIG. 516 may move to a position corresponding to a second control input to continue training the model. In some aspects, the video may be a live stream of the user 518 provided by the camera 116 of the action control system 106. In some aspects, the model may be trained using a set of video data that may include a plurality of users executing user actions corresponding to control inputs. It should be appreciated, that the animated FIG. 506 is one non-limiting example and additional and/or alternative animated figures are envisioned.

FIG. 6 is a schematic 600 of the action control system 106 implementing one or more control inputs 602 based on one or more user actions 604, in accordance with certain aspects of the current application. The schematic 600 includes a device 605 of the controlled system 104. The device 605 may include a display that may be used to display a user interface 606 of the animated controlled system 104. The user interface 606 may include an animated scene 608 within an animated application. The user interface 606 may also include the parameters toolbar 508 with the user control indication button 510, model training button 512, user action set selection button 514, and one or more additional buttons. The parameters toolbar 508 may be used during implementation of the action control system 106. For example, the user control indication button 510 may be selected within the parameters toolbar 508 to initiate user action-based control of one or more components of the animation application.

The schematic 600 also includes a hand 610 of a user 612. The hand of the user 612 may perform the user actions 604 though movement of the hand 610. To aid the discussion, a set of animated axes 614 and a set of user action axes 616 will be referenced. The animated axes 614 are aligned with the animated scene 608. The set of animated axes 614 represent three dimensions and include x-axis 618, a y-axis 620 and a z-axis 622. The x-axis 618 may run along an x-plane of the animated scene 608, the y-axis 620 may run along a y-plane of the animated scene 608 (e.g., perpendicular to the x-plane). The z-axis 622 may run along a z-plane of the animated scene 608 out of an interface of the device 605 (e.g., perpendicular to each of the x-axis 618 and y-axis 620). The user action axes 616 are aligned with the hand 610 of the user 612 but are illustrated offset from the hand 610 for illustrative purposes. The set of user action axes 616 represent three dimensions and include x-axis 624, a y-axis 626 and a z-axis 628. The x-axis 624 may run along from a back side of the hand 610 to the palm of the hand 610, the y-axis 626 may run along from a tip of a finger of the hand 610 to the palm (e.g., perpendicular to the x-axis 624). The z-axis 628 may run out perpendicular to each of the x-axis 624 and y-axis 626 out of the plane of FIG. 6.

In some aspects, the user actions 604 may be captured by a camera 116 of the action control system 106. In the illustrated example, the user actions 604 may be associated with the control inputs corresponding to movement of an animation camera 630 of the animation software. Movement of the hand 610 along the x-axis 624 and the y-axis 626 of the user action axes 616 may be used to direct the animation camera 630 to move along the x-axis 618 and the y-axis 620 of the animated axes 614. For example, the hand 610 may move from a first position 632 to a second position 634. As such, the user actions 604 may direct the control input 602 to move the animation camera 630 from a first frame 636 to a second frame 638.

In some aspects, the user actions 604 may be associated with control inputs corresponding to the animation camera 630 zooming in and/or zooming out. For example, movement of the hand 610 along the z-axis 628 of the user action axes 616 may be used to zoom the animation camera 630 into a portion of the animated scene 608. The hand 610 may move from a second position 634 to a third position 640. As such, the user actions 604 may direct the control input 602 to move the animation camera 630 from the second frame 638 to a third frame 642, zooming in on a fish. As shown, the user actions 604 may be used to execute the control inputs 602, such as moving the animation camera 630 around the animated scene 608 of the animation application.

FIG. 7 is a schematic 700 of the action control system 106 implementing a user action sequence 702 associated with implementation of an animation sequence 704, in accordance with aspects of the present technique. The schematic 700 includes a device 605 of the controlled system 104. The device 605 may include a display that may be used to display a user interface 706 of the animated controlled system 104. The user interface 706 may include an animated scene 708 within an animated application. The user interface 706 may also include the parameters toolbar 508 with the user control indication button 510, model training button 512, user action set selection button 514, and one or more additional buttons. The parameters toolbar 508 may be used during implementation of the action control system 106. For example, the user control indication button 510 may be selected within the parameters toolbar 508 to initiate user action-based control of one or more components of the animation application. To aid the discussion, the set of animated axes 614 and the set of user action axes 616 will again be referenced.

The schematic 700 also includes a hand 610 of a user 612. The hand of the user 612 may perform the user action sequence 702 though movement of the hand 610 from a first user action 710, to a second user action 712, to a third user action 714. In some aspects, the user action sequence 702 may be captured by a microphone 114, a camera 116, or a combination thereof of the action control system 106. The user action sequence 702 may cause an animated FIG. 716 within the animated application to execute the animation sequence 704 associated with the user action sequence 702 as determined by the model of the action control system 106.

In some aspects, the animation sequence 704 may include animating the animated FIG. 716 to stop, drop, and roll. As such, the first user action 710, an open palm corresponds to a first animation 718 of the animation sequence 704, stop. The second user action 712, a closed fist, corresponds to a second animation 720 of the animation sequence 704, drop. The third user action 714, a peace sign, corresponds to a third animation 722 of the animation sequence 704, roll. In this manner, when the user 612 performs the user action sequence 702 the action control system 106 may control the animated FIG. 716 to perform the animation sequence 704. In some aspects, repetition of one of the steps of the user action sequence 702 may cause the animated FIG. 716 to execute the corresponding animation repetitively. For example, the user 612 may continue to provide the third user action 714, the peace sign, directing the animated FIG. 716 to continue rolling.

It should be noted, that the user 612 and the user action sequence 702 described is one non-limiting aspect of the disclosed action control system 106. In some aspects, it is envisioned that an action sequence used as an input for the action control system 106 may be received from a group of users. For example, a group of users may perform the action sequence and an animation sequence or one or more additional effects may be generated based on actions of the group of users. In some instances, the group of users may be located within a user area (e.g., a theater, a ride vehicle). The users may be prompted to perform the action sequence to control the animation sequence or effect (e.g., driving a car, casting a spell, building a bridge) performed via the special effects system 107. The users may be seated in the user area and perform the action sequence (e.g., raising hands, mimicking steering) to control the special effects system 107 (e.g., projection effects, display effects, audible effects). It should be noted, that the action sequence performed by the group of users may be dissimilar to the animated sequence performed in response to the input. Further, in some aspects, the action control system 106 may be pretrained using one or more additional group of users.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method comprising:
receiving a pre-programmed control input, wherein the control input is configured to initiate a digital command within an operating system or software application;
receiving one or more user actions to implement the pre-programmed control input, wherein the one or more user actions are not associated with the pre-programmed control input;
training a model to dynamically associate the one or more user actions with the pre-programmed control input, the digital command, or both based on receiving the one or more user actions proximate to receiving the control input;
identifying, via the trained model, the one or more user actions;
identifying, via the trained model, the associated pre-programmed control input, the associated digital command, or both; and
implementing the associated pre-programmed control input, the associated digital command, or both.

2. The computer-implemented method of claim 1, wherein the one or more user actions are dissimilar to the associated pre-programmed control input.

3. The computer-implemented method of claim 1, wherein the one or more user actions are generalized to one or more additional user actions received from a user or a group of users.

4. The computer-implemented method of claim 1, comprising:
identifying one or more key features within a user area, wherein the key features are monitored to determine if the one or more user actions are executed.

5. The computer-implemented method of claim 1, wherein the one or more user actions is an expression, a gesture, a movement, a sound, or a combination thereof, and wherein the control input is an animation effect, an animation sequence, a command, or a combination thereof.

6. The computer-implemented method of claim 1, comprising:
training the model to predict associations of one or more additional pre-programmed control inputs with one or more additional user actions based upon the predicted association of the one or more user actions, the received pre-programmed control input, or both.

7. The computer-implemented method of claim 6, comprising:
receiving, via a user interface, the one or more additional pre-programmed control inputs;
receiving, via the user interface, one or more control input parameters indicative of implementing the model or training the model; and
identifying the one or more control input parameters based upon the one or more user actions.

8. (canceled)

9. The computer-implemented method of claim 1, wherein the pre-programmed control input is an animation sequence within the operating system or software application and wherein the one or more user actions is an action sequence.

10. The computer-implemented method of claim 1, wherein the one or more user actions comprise a first set of user actions and a second set of user actions, and wherein the second set of user actions replaces the first set of user actions upon input.

11. A system, comprising:
processing circuitry; and
memory, accessible by the processing circuitry, the memory storing instructions that, when executed by the processing circuitry, cause the processing circuitry to perform operations comprising:
identifying, via a trained model, a user action;
subsequent to identifying the user action, identifying, via the trained model, an associated pre-programmed control input, wherein the associated pre-programmed control input is an animation sequence within an operating system or software application; and
implementing the associated pre-programmed control input based on the user action.

12. The system of claim 11, wherein the processing circuity performs operation comprising:
receiving a pre-programmed control input, wherein the pre-programmed control input is configured to initiate a digital command within the operating system or software application;
receiving the one or more user actions after receiving the pre-programmed control input to implement the control input, wherein the one or more user actions are not associated with the pre-programmed control input; and
training a model to dynamically associate the one or more user actions with the pre-programmed control input, the digital command, or both based on receiving the one or more user actions proximate to receiving the pre-programmed control input.

13. The system of claim 11, wherein the user action is an expression, a gesture, a movement, a sound, or a combination thereof, and wherein the associated pre-programmed control input is an animation effect, an animation sequence, a command, or a combination thereof.

14. The system of claim 11, wherein the one or more user actions are dissimilar to the associated pre-programmed control input and wherein the one or more user actions do not mimic the associated pre-programmed control input.

15. The system of claim 11, wherein the processing circuity performs operation comprising:
further training the trained model to predict associations of one or more additional pre-programmed control inputs with one or more additional user actions based upon the association of the user action, the associated pre-programmed control input, or both.

16. The system of claim 11, wherein the processing circuity performs operation comprising:
identifying one or more key features within a user area, wherein the key features are monitored to determine if the user action is executed.

17. A tangible, non-transitory, computer-readable storage medium, comprising computer-readable instructions that, when executed by one or more processors of one or more computers, cause the one or more computers to:
receive a pre-programmed control input, wherein the pre-programmed control input is configured to initiate a digital command within an operating system or software application;
identify one or more key features within a user area, wherein the key features are monitored to determine if one or more user actions are executed;
receive the one or more user actions to implement the pre-programmed control input, wherein the one or more user actions are not associated with the pre-programmed control input;
train a model to dynamically associate the one or more user actions with the pre-programmed control input, the digital command, or both based on receiving the one or more user actions proximate to receiving the pre-programmed control input;
identify, via the trained model, the one or more user actions;
identify, via the trained model, the associated pre-programmed control input, the associated digital command, or both; and
implement, via a user interface, the associated pre-programmed control input, the associated digital command, or both.

18. The tangible, non-transitory, computer-readable storage medium of claim 17, comprising computer-readable instructions that, when executed by the one or more processors of the one or more computers, cause the one or more computers to:
train the model to associate one or more additional pre-programmed control inputs with one or more additional user actions based upon the association of the one or more user actions, the received pre-programmed control input, or both.

19. The tangible, non-transitory, computer-readable storage medium of claim 18, wherein the one or more user actions is an expression, a gesture, a movement, a sound, or a combination thereof, and wherein the pre-programmed control input is an animation effect, an animation sequence, a command, or a combination thereof.

20. The tangible, non-transitory, computer-readable storage medium of claim 19, comprising computer-readable instructions that, when executed by the one or more processors of the one or more computers, cause the one or more computers to:
receive, via the user interface, one or more control input parameters indicative of implementing the model or training the model.

21. The computer-implemented method of claim 1, comprising predicting, via the trained model, associations of one or more additional control inputs with one or more additional user actions.
